(19) United States
(12) Patent Application Publication
(10) Pub. No.: US 2005/0100767 A1
(43) Pub. Date: May 12, 2005

(54) Fuel cell with solid hydrogen storage and system for off-board servicing

(76) Inventor: Aladar Stolmar, Pittsburgh, PA (US)

Correspondence Address: CLIFFORD A. POFF, 9800B MCKNIGHT ROAD, SUITE 115, PITTSBURGH, PA, 15237, US

(21) Appl. No.: 10/914,754

(22) Filed: Aug. 9, 2004

Related U.S. Application Data
(60) Provisional application No. 60/493,978, filed on Aug. 8, 2003.

(51) Int. Cl. H01M 8/00; B60L 11/18

(52) U.S. Cl. 429/13; 429/34; 180/65.3

(57) ABSTRACT

An off-board refueling/refurbishing system for an integrated hermetically sealed fuel cell and solid hydrogen storage power plant, used to power transportation means operated and used by the public. A replaceable power plant package is handled in a refueling station where the sealed power plant package with depleted fuel and optional discharged electrical accumulator is removed from a vehicle and replaced with a refueled and recharged package. A separate recharging/refurbishing facility is provided where the waste product is removed from the depleted power plant package, the fuel cell and the solid hydrogen storage are tested and refurbished as needed.

### CROSS-REFERENCE TO RELATED APPLICATIONS

This application claims the benefit of U.S. Provisional patent application Ser. No. 60/493,978, filed Aug. 8, 2003 entitled Integrated fuel cell & solid hydrogen storage off-board refueling system

### BACKGROUND OF THE INVENTION

1. Field of the Invention

The present invention relates to an integrated hermetically sealed fuel cell and solid hydrogen storage power plant an off-board refueling/refurbishing system and to services thereby and used in public transportation to power buses, cars, trucks, recreational vehicles. More particularly, to a sealed power plant package replaceable at a refueling station where the power plant package with depleted fuel and optional discharged electrical accumulator is removed from the vehicle and replaced with a refueled and recharged package.

2. Description of the Prior Art

It is known in the art to use of hydrogen as fuel in vehicles used for public transportation. The hydrogen fuel is stored on board the vehicle in combination with electrical energy generation means. Different fuel cells designs; several methods of hydrogen generation and delivery of the hydrogen are known and in use today. However, common refueling problems bear the same characteristics of the prior art found in gasoline fuel refueling operations. More serious is the possibility of leakages or spillages of hydrogen during refueling or operation of vehicle or while the vehicle is unattended such as parked. This invention relates generally and specifically to the separation of the public operating or using the hydrogen fueled vehicles from the hydrogen in any, including accidental conditions of operations, including the refueling.

### SUMMARY OF THE INVENTION

Accordingly, it is an object of the present invention to resolve security issues associated with the use of hydrogen as fuel for privately owned or used publicly used transportation vehicles such as cars, trucks, buses, and recreational vehicles.

It is another object of this invention to provide a uniform off-board refueling/refurbishing system for a hermetically sealed fuel cell with an integrated solid hydrogen storage power plant package which is regenerative, if desired, for powering a transportation vehicle operated or used by the public.

It is further object of this invention to eliminate hazards incident to replacing the power plant package at a refueling station where a sealed power plant package with depleted fuel and optional discharged electrical accumulator is removed from the vehicle and replaced with a refueled and recharged package by a robot in a very short duration (few seconds) operation, comparable to the pay stops on the toll roads.

A further feature of the present invention resides in the use of an infrastructure of separate recharging/refurbishing facilities where the waste product is removed from the power plant package, the fuel cell and the solid hydrogen storage are tested and refurbished as needed and the fuel is replenished and the optionally included accumulator is recharged in a highly automated facility.

The possibility of leakages during the operation is eliminated by the sealed design of the power plant package, the spillages are completely eliminated from the refueling, since the hermetically sealed package is completely replaced, it has no openings, just the electrical and mechanical connections. The special ports for refurbishing could be opened only by special tools, available only in the secure safe refueling/refurbishing facility.

The use of the method and apparatus of the invention makes the Hydrogen fuel less harmful and less hazardous then the current use of gasoline fuel is.

### BRIEF DESCRIPTION OF THE SEVERAL VIEWS OF THE DRAWINGS

The present invention will be more fully understood when the following description is read in light of the accompanying drawings in which:

FIG. 1 is a schematic illustration of an off board refueling system according to the present invention for refueling of a vehicle used by the public and servicing depleted power plant packages;

FIG. 2 is an enlarged illustration of handling of power plant packages in the refueling system;

FIG. 3 is an isometric illustration of the exterior of a power plant package embodying the features of the present invention; and

FIG. 4 is a isometric illustration of internal components of the power plant package shown in FIG. 3.

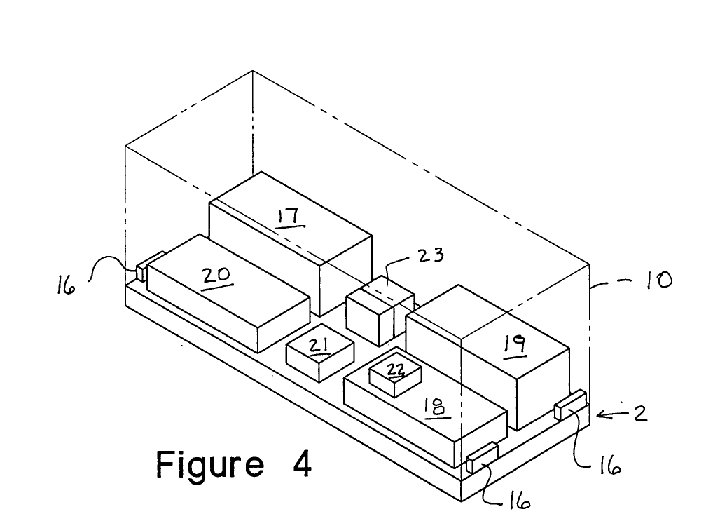

### DETAILED DESCRIPTION OF THE INVENTION

The invention provides a hydrogen fuel based transportation infrastructure for general public, characterized by complete and safe separation of the public operating or using the transportation vehicles from the Hydrogen fuel. More particularly, there is described herein the use of hermetically enclosed integrated regenerative fuel cell and fuel storage packages mounted on the vehicles, optionally integrated with electrical accumulator batteries; their automated replacement in a short term refueling operation; and their refueling and refurbishing in a dedicated highly automated facility.

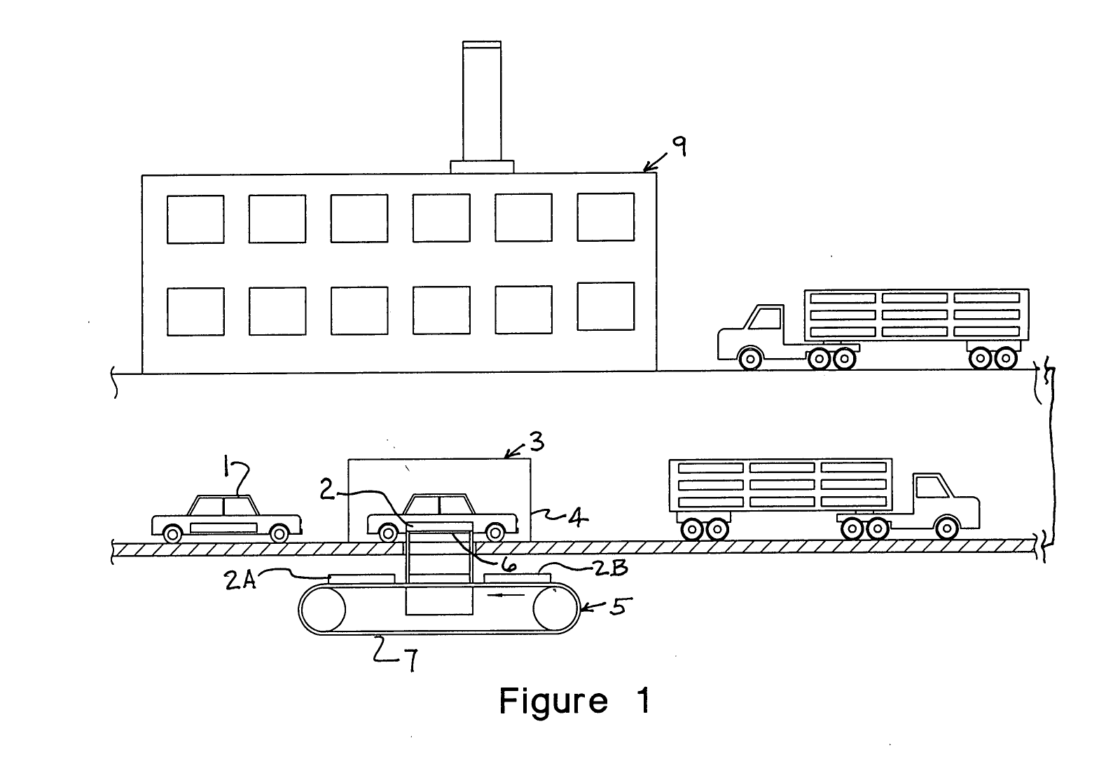

A feature of the present invention illustrated in FIG. 1 provides for off loading of a power plant package from publicly used vehicles and installing a refueled power plant package in an anti-thief secure environment refueling. The invention provides that an anti-thief secure environment is also maintained at a remote site for fueling including recharging and refurbishing of the power plant packages. A vehicle 1 for disclosing the present invention is described as a passenger automobile of a type where propulsion is accomplished by electrically powered motors supplied with current from a power plant package 2 comprised of a fuel cell and solid hydrogen storage facility. The details of the construction of the power plant package 2 will be set forth hereinafter. A operator controls advancement of the vehicle 1 along a roadway to a refilling station 3 including a building structure 4 subdivided by reinforced wall structures sufficient to protect against unauthorized entrance to a secure refilling system 5 underlying the usual chassis of the vehicle 1. The secure refueling system includes an elevator platform 6 containing robot controlled devices 6A enclosed by access chute 6B used to protectively house the work site under the chassis of the vehicle. The robot controlled devices 6A provide automated operation to operate mechanical and utility quick disconnect connectors for disconnecting and connecting mounting hardware, power supply and control systems strategically located in external walls of the power plant package 2 to allow for the removal of a power plant package in the vehicle and immediate replacement at the secure work site. The refueling of the passenger automobile 1 is completed by a commercial transaction that authenticates power package replacement and other commercial events such as payment of charges for the refueling process. A local computerized control system using a communication link, such as a telephone line or and internet link, per se well known in the art, provides the means of recording the transactions of goods and the associated financial transactions. It is understood by those skilled in the art that more than one power plant package may be used to power a vehicle such as heavy duty busses and trucks. In the event more than one power plant package must be replaced in a vehicle, the secure refueling system including elevator platform 6 containing robot controlled devices 6A enclosed by access chute 6B are used repeatedly in the protectively housed work site under the chassis of the vehicle to complete the refueling process for such busses and trucks. The uniform construction of the power plant package is enables the repetitive use of the same facilities for the power plant package replacement operations.

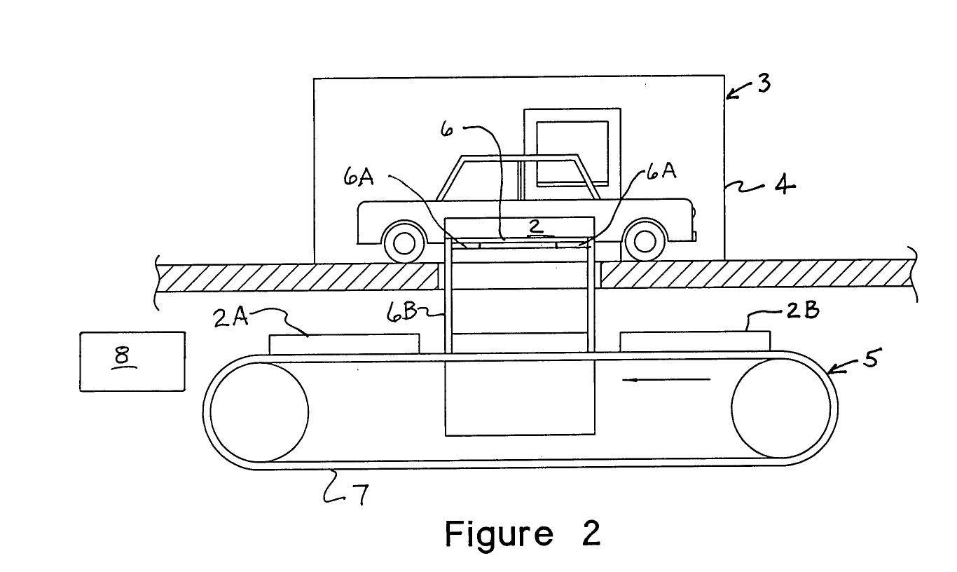

As shown in FIG. 2, an energy depleted power plant package 2A is transported by a conveyer 7 and additional transport devices, if necessary, for accumulation at a local short term storage site 8. The storage site 8 is subdivided to provide distally spaced and secure short term storage sites, one such storage site for discharged power plant packages and another such storage site for refurbished, recharged power plant packages. The conveyer 7 also advances the replacement power plant package 2B to the secure work site of the secure filling system 5. The power energy depleted plant packages 2A collected at the local short term storage site 8 await transport by a truck or other suitable handling systems to a distantly located refueling plant 9. The separately located recharging/refurbishing facility provided by the refueling plant 9 enables safe and secure place where the waste product is removed from the power plant package, the fuel cell and the solid hydrogen storage are tested and refurbished as needed and the fuel is replenished and the optionally included accumulator is recharged. The refueling plant includes robotically automated testing, refurbishing, recharging and tracking of power plant packages supplied by the one or more transport vehicle to reduce personnel exposure to the hazards of the refueling and testing operations and also provide a record of proceedings in the operation of the refueling plant. The robotic operation of the refueling plant includes computer controls to manage the resources such as hydrogen fuel and storages of refurbishing material and sources including replenishment of the resources. The computer controls ensure maximum safety for the general public and the operating personnel as well automation to eliminate the need for direct exposure to the harmful materials and ensure a safe and securely operated testing and filling plant.

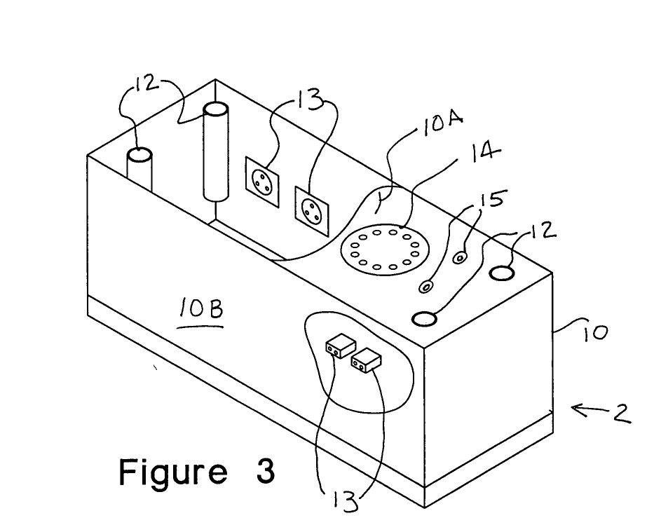

FIG. 3 illustrates the details of the construction of the power plant package 2. A casing 10 with heat exchanger tubing and fins is secured to the chassis of the vehicle 1 by mechanical suspension members 12 including fasteners distributed about the corner areas of the top wall 10A of the casing 10. The casing 10 is robustly constructed, pressure tested and sized for sustained integrity under all foreseeable conditions including, for example, extreme accidental conditions to ensure a hermetical sealed enclosure. Electrical power connectors 13 are accessible in a vertical sidewall 10B of the casing for receiving quick disconnect connectors which are robotically operated for disconnecting and connecting power supply system including electrical transmission lines for the electric motors of the vehicle 1. An array of access ports 14 are provide in the top wall 10A for refueling and discharging waste products from the power plant package 2. The robot controlled devices 6A also operate mechanical and utility quick disconnect connectors for disconnecting and connecting utility hardware with the array of access ports 14 as necessary to allow for the removal of a power plant. Electrical control connectors 15 are provide in the top wall 10A of the casing for receiving quick disconnect connectors which are robotically operated for disconnecting and connecting electrical system including electrical lines for controlling the operation of the power plant package on board the vehicle 1. Inside the power plant package 2 there is an electrical lock 16 providing a handshake security for the mechanical suspension members 12. A protective storage system 17 provides an on board supply of solid hydrogen fuel. A power pack temperature control system 18 maintains a stable temperature environment in a power pack. A fuel cell 19 is coupled by suitable plumbing and wiring for operation to convert hydrogen fuel to electrical current which is actively stored and used from a battery pack 20. The fuel cell operation is reversely controlled by a controller 21 to allow for a regeneration of hydrogen fuel from electrical energy supplied to the power pack under options which include dynamic braking of the vehicle using the propelling electrical motors as generators or an external source of electrical energy. Controller 21 is also, if desired, coupled through the quick electrical connectors 15 for the control of energy release and for regeneration of energy in braking operations. A valve 22 enables draining water from the power pack as necessary including, for example, refurbishing operations. A safety and temperature proofing control 23 is connected to maintain a safe temperature of the hydrogen storage tank system 17.

While the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

1. A method for refueling and refurbishing a hermetically sealed fuel cell for powering a transportation vehicle, said method including the steps of:
providing including integrated solid hydrogen storage power plant packages, said integrated power plant packages each having quick electrical and mechanical connection facilities for use onboard to power a transportation vehicle,
providing refueling stations having robotic mechanized removal and replacement facilities in a secured environment for refueling of a transportation vehicle by the exchange of discharged integrated reversible fuel cell and solid hydrogen storage power plant with charged integrated fuel cell and solid hydrogen storage power plant; and
providing a testing, refueling and refurbishing facility in a secure environment remote to said refueling stations to recharge said discharged integrated solid hydrogen storage and fuel cell power plant.

2. The method according to claim 1 wherein said robotic mechanized removal and replacement facilities in a secured environment have robot controlled devices to operate mechanical and utility quick disconnect connectors for disconnecting and connecting mounting hardware, power supply and control systems strategically located in external walls of the power plant package.

3. The method according to claim 1 wherein said refueling stations have facilities for commercial transactions that authenticates power package replacement and payment of charges for said refueling of a transportation vehicle.

4. The method according to claim 1 wherein said step of providing refilling stations include a building structure subdivided by reinforced wall structures to protect against unauthorized entrance to said secured environment underlying a chassis of a vehicle.

5. The method according to claim 4 wherein said secured environment includes an elevator platform containing robot controlled devices enclosed by an access chute protectively housing a work site under the said chassis of a vehicle.

6. A power plant package for a vehicle, said package including:
a casing robustly constructed for sustained integrity to ensure a hermetical sealed enclosure.
a fuel cell in said casing;
a solid hydrogen fuel storage reservoir operatively coupled to said fuel cell in said casing;
a storage reservoir for receiving liquid waste from operation of said fuel cell;
electrical connections for the control of energy released from said fuel cell and for regeneration energy in braking operations of a vehicle;
access ports and connections for facilities remote to a vehicle for refurbishing, testing, waste discharge and refueling operation within said casing; and
mechanical connections for secure quick mounting and demounting of said casing on a vehicle.

7. The power plant package according to claim 6 further including an accumulator battery in said casing for storage of electrical energy released by said fuel cell and electrical energy regenerated in braking operations of a vehicle.

8. The power plant package according to claim 7 wherein said electrical connections include quick disconnect electrical connections for the discharging the generated and/or stored energy from said accumulator battery.

9. A refueling system for power plant package in vehicles, said refueling system including:
dispersed refilling building structures serviced by at least one transport vehicle operating between said dispersed refilling building structures and distantly located refueling plant for transport of discharged power plant packages and refurbished, recharged power plant packages, each of said refilling building structures including:
a building structure subdivided by walls sufficient for a secure work site to protect against unauthorized entrance to a secure refilling system underlying a chassis of the vehicle when residing therein;
robot controlled devices in said secure work site for automated operation of mechanical and utility connectors to disconnect and connect mounting hardware, power supply and control systems accessible in external walls of a power plant package to effect replacement a power plant package at the secure work site;
distally spaced and secure short term storage sites, one such storage site for discharged power plant packages and another such storage site for refurbished, recharged power plant packages;
means of recording the transactions of goods and the associated financial transactions arising out of the replacement of refurbished, recharged power plant packages at said building structure.

10. The refueling system according to claim 9 wherein said refueling plant includes robotically automated testing, refurbishing, recharging and tracking of power plant packages supplied by said at least one transport vehicle to reduce personnel exposure to the hazards recording of proceedings in the operation of said refueling plant.

11. The refueling system according to claim 9 wherein said refueling plant includes computer controls for said robotically automated testing, refurbishing, recharging and tracking of power plant packages with means of fuel and refurbishing material storages and sources and means of their replenishment.
